(19) United States
(12) Patent Application Publication
(10) Pub. No.: US 2025/0316224 A1
(43) Pub. Date: Oct. 9, 2025

(54) CONTROL UNIT FOR DISPLAY DEVICE, DISPLAY DEVICE, AND METHOD OF CONTROLLING DISPLAY DEVICE

(71) Applicant: SHARP KABUSHIKI KAISHA, Sakai City, Osaka (JP)

(72) Inventors: Mohammad Reza KAZEMI, Sakai City, Osaka (JP); MASAFUMI UENO, Sakai City, Osaka (JP); MASAAKI MORIYA, Sakai City, Osaka (JP); Masafumi KAWAI, Sakai City, Osaka (JP); NAOKI SHIOBARA, Sakai City, Osaka (JP); HIROYUKI FURUKAWA, Sakai City, Osaka (JP)

(21) Appl. No.: 18/865,544

(22) PCT Filed: May 17, 2022
(86) PCT No.: PCT/JP2022/020447

§ 371 Date: Nov. 13, 2024

(51) Int. Cl. G09G 3/3225

(52) U.S. Cl. CPC G09G 3/3225; G09G 2320/046

(57) ABSTRACT

A control unit for a display device includes a display panel including a plurality of self-luminous elements, the control unit including a displacement control unit configured to, while causing to displace a position in the display panel where an image is displayed on the display panel, stop the displacement of the position of the image in the display panel when a viewing signal is received that indicates that a viewer is likely to be watching the display panel.

### TECHNICAL FIELD

The present disclosure relates to a control unit for a display device, a display device, and a method of controlling a display device.

### BACKGROUND ART

Display devices have been developed that include a display panel including a plurality of self-luminous elements. In such display devices, a phenomenon called image burn-in may occur in the display panel if the plurality of self-luminous elements are kept turned on at high luminance for an extended period of time. Therefore, as disclosed in Patent Literature 1 listed below, attempts have been made to restrain image burn-in in the display panel by displacing the position of the image displayed on the display panel upwards, downwards, leftwards, or rightwards in the display panel at regular intervals.

### CITATION LIST

### Patent Literature

Patent Literature 1: Japanese Unexamined Patent Application Publication No. 2006-013913

### SUMMARY OF INVENTION

### Technical Problem

However, in the technique disclosed in Patent Literature 1 above, the position of the image may be displaced in the display panel while the viewer is watching the display surface of the display panel. When this is actually the case, the viewer could be undesirably distracted by the displacement of the position of the image even if the displacement of the position of the image in the display panel is small.

The present disclosure has been made in view of this problem. It is an object of the present disclosure to provide a control unit for a display device, a display device, and a method of controlling a display unit each of which is capable of restraining the viewer from being undesirably distracted by the displacement, of the position of the image in the display panel, that is intended to restrain image burn-in.

### Solution to Problem

The present disclosure is directed to a control unit for a display device including a display panel including a plurality of self-luminous elements, the control unit including a displacement control unit configured to, while causing to displace a position in the display panel where an image is displayed on the display panel, stop the displacement of the position of the image in the display panel when a viewing signal is received that indicates that a viewer is likely to be watching a display surface of the display panel.

The present disclosure is directed to a display device including: a display panel; and the control unit for the aforementioned display device.

The present disclosure is directed to a method of controlling a display device, the method including: a step of displacing a position in a display panel where an image is displayed on the display panel; and a step of, while displacing the position, stopping the displacement of the position of the image in the display panel when a viewing signal is received that indicates that a viewer is likely to be watching the display surface of the display panel.

### BRIEF DESCRIPTION OF DRAWINGS

FIG. 1 is a diagram illustrating a displacement, in a display panel of a display device in accordance with Embodiment 1, of the position of an image displayed on the display panel.

FIG. 2 is a functional block diagram of a configuration of the display device in accordance with Embodiment 1.

FIG. 3 is a flow chart representing a process performed by a control unit for the display device in accordance with Embodiment 1.

FIG. 4 is a cross-sectional view of a display panel for a variation example of the display device in accordance with Embodiment 1.

FIG. 5 is a front view of a display device including first roll-up units as another example of a display device in accordance with Embodiment 2.

FIG. 6 is a front view of a display device including second roll-up units as yet another example of the display device in accordance with Embodiment 2.

FIG. 7 is a cross-sectional view of a display device including either the first roll-up units as another example of the display device in accordance with Embodiment 2 or the second roll-up units as yet another example of the display device in accordance with Embodiment 2.

FIG. 8 is a functional block diagram of a configuration of the display device in accordance with Embodiment 2.

FIG. 9 is a functional block diagram of an internal configuration of a face sensor in the display device in accordance with Embodiment 2.

FIG. 10 is a flow chart representing a process performed by a control unit for the display device in accordance with Embodiment 2.

FIG. 11 is a cross-sectional view of a display panel for a variation example of the display device in accordance with Embodiment 2.

FIG. 12 is a front view of the display panel for the variation example of the display device in accordance with Embodiment 2.

FIG. 13 is a cross-sectional view of a display panel for another variation example of the display device in accordance with Embodiment 2.

FIG. 14 is a cross-sectional view of an overall structure of a display device in accordance with Embodiment 3.

FIG. 15 is a cross-sectional view of a display panel and a rotation mechanism for another example of the display device in accordance with Embodiment 3.

FIG. 16 is a cross-sectional view of a display panel for yet another example of the display device in accordance with Embodiment 3.

FIG. 17 is a perspective view of a display panel for yet another example of the display device in accordance with Embodiment 3.

FIG. 18 is a perspective view illustrating a relationship between a display panel and a housing for yet another example of the display device in accordance with Embodiment 3.

FIG. 19 is a functional block diagram of a configuration of a display device in accordance with Embodiment 4.

FIG. 20 is a diagram illustrating a degraded area before a displayed image is displaced in a display panel of the display device in accordance with Embodiment 4.

FIG. 21 is a diagram illustrating a degraded area while a displayed image is being displaced in the display panel of the display device in accordance with Embodiment 4.

FIG. 22 is a diagram illustrating a degraded area being hidden inside the display panel after a displayed image is displaced in the display panel of the display device in accordance with Embodiment 4.

FIG. 23 is a flow chart representing a process performed by a control unit for the display device in accordance with Embodiment 4.

FIG. 24 is a flow chart representing a process performed by a control unit for a display device in accordance with Embodiment 5.

FIG. 25 is a cross-sectional view of an overall structure of a display device in accordance with Embodiment 6.

FIG. 26 is a front view of the overall structure of the display device in accordance with Embodiment 6.

FIG. 27 is a functional block diagram of a configuration of the display device in accordance with Embodiment 6.

FIG. 28 is a graph representing a relationship between the temperature of a display panel of the display device in accordance with Embodiment 6, the displacement speed of the position in the display panel where an image is displayed, and the displacement speed of the display panel itself.

FIG. 29 is a flow chart representing a process performed by a control unit for the display device in accordance with Embodiment 6.

FIG. 30 is a cross-sectional view of a structure of a part of a display device in accordance with Embodiment 7.

FIG. 31 is a diagram illustrating an exemplary display state when a display panel of the display device in accordance with Embodiment 7 is not rotated.

FIG. 32 is a diagram illustrating an exemplary display state when the display panel of the display device in accordance with Embodiment 7 is rotated.

FIG. 33 is a functional block diagram of a configuration of the display device in accordance with Embodiment 7.

FIG. 34 is a flow chart representing a process performed by a control unit for the display device in accordance with Embodiment 7.

### DESCRIPTION OF EMBODIMENTS

The following will describe a control unit for a display device and a method of controlling the display device in accordance with embodiments of the present disclosure with reference to drawings. Note that identical and equivalent elements in the drawings are denoted by the same reference numerals, and description thereof is not repeated.

Note that the display devices in accordance with the embodiments of the present disclosure can be used as, for example, display devices for digital signage and display devices for on-board driver consoles as well as display devices for television units. In the case of digital signage and on-board display devices, a person around the display device is not always watching the display surface of the display device on which an image is displayed. There are times when a person around the display device is watching the display surface of the display device and times when a person around the display device is not watching the display surface of the display device. The control unit for a display device and the method of controlling a display device in accordance with the present disclosure are effective in display devices in which such a situation can occur.

### Embodiment 1

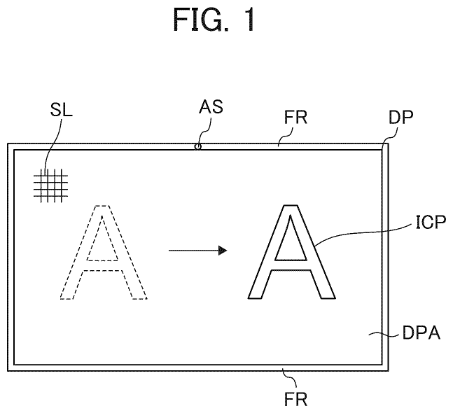

Referring to FIGS. 1 to 4, a description is given of a control unit CT for a display device 100 and a method of controlling the display device 100 in accordance with Embodiment 1.

FIG. 1 is a diagram illustrating a displacement, in a display panel DP of the display device 100 in accordance with Embodiment 1, of the position of an image ICP displayed on the display panel DP.

Referring to FIG. 1, the position of the image ICP displayed on the display panel DP is displaced in the display panel DP if the position of the display panel DP itself is not displaced. This displacement of the position of the image ICP in the display panel DP is achieved by the control unit CT (detailed later) controlling the image data fed from a processing unit PU to the display panel DP.

Referring to FIG. 1, the display device 100 includes a proximity sensor AS. The display device 100 uses a flat touch display device as the display panel DP in the present embodiment. The display device 100 in accordance with the present embodiment displaces the position of the image ICP in the display panel DP to restrain image burn-in of the display panel DP, until the proximity sensor AS detects a person approaching a position that is in a prescribed range from the display panel DP. The “position that is in a prescribed range” in this context is, for example, a position that is at a distance of less than 10 cm from the display surface of the display panel DP. Therefore, the display device 100 may be described as displacing the position of the image ICP in the display panel DP until it is detected that a person is likely to be watching the display surface of the display panel DP. The proximity sensor AS in accordance with the present embodiment is disposed on the front face of a frame FR of the display panel DP and may alternatively be disposed in a location other than on the front face of the frame FR.

The display panel DP in accordance with the present embodiment may be anything as long as the display panel DP includes a plurality of self-luminous elements SL. The display panel DP includes, for example, OLEDs (organic light-emitting diodes) as the self-luminous elements SL. It should be understood however that the self-luminous elements SL may be QLEDs (quantum dot light-emitting diodes). Alternatively, the self-luminous elements SL may be, for example, micro-LEDs (light-emitting diodes) or mini-LEDs (light-emitting diodes).

The display panel DP including the self-luminous elements SL has image burn-in problems. The image burn-in of the display panel DP is in most cases caused by a continuous, high luminance display over an extended period of time of a still or single image by the same pixels on the display surface. Therefore, the display device 100 in accordance with the present embodiment displaces, in the display panel DP, the position of the image ICP displayed on the display panel DP as described above, to restrain image burn-in of the display panel DP. In other words, different pixels (self-luminous elements SL) in the display panel DP are turned on to display the image ICP on the display panel DP.

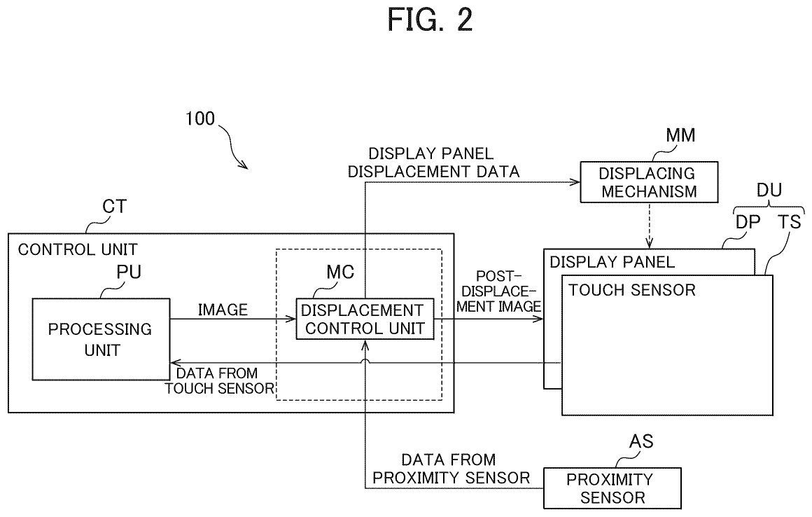

FIG. 2 is a functional block diagram of a configuration of the display device 100 in accordance with Embodiment 1.

The display device 100 includes a display unit DU, a displacing mechanism MM, the control unit CT, and the proximity sensor AS. The display unit DU includes the display panel DP and a touch sensor TS. The control unit CT includes the processing unit PU and a displacement control unit MC.

The display panel DP includes the plurality of self-luminous elements SL. The display panel DP is rectangular in a front view and generally planar. The display panel DP has a frontally rectangular and planar display surface. The display panel DP is a planar display panel with zero flexibility and softness. It should be understood however that the display panel DP may be a planar display panel with some flexibility or softness.

The displacing mechanism MM displaces the display surface of the display panel DP parallel to the display surface along the display surface in accordance with an instruction signal transmitted from the displacement control unit MC. The displacing mechanism MM may be a rack and pinion system (not shown) including: a motor; a pinion gear rotated by the motor; and a rack that linearly reciprocates with the pinion gear. The displacing mechanism MM in accordance with the present embodiment may be any mechanism that can displace the display panel DP so that the display panel DP can reciprocate.

The displacing mechanism MM may displace the display panel DP in any of the following manners.

(1) The display panel DP is displaced upwards and downwards along the planar display surface of the display panel DP.

(2) The display panel DP is displaced to the left/right along the planar display surface of the display panel DP.

(3) The display panel DP is rotated in an in-plane direction of the planar display surface of the display panel DP around an imaginary line that is perpendicular to the display surface.

The touch sensor TS detects an instructive operation (contact or approach) made using an instructive operation member, such as a finger or a touch pen, approaching the display panel DP. The touch sensor TS may be anything, for example, an electrostatic capacity sensor, a resistance sensor, or an infrared sensor. Note that the infrared sensor is assumed to be included in a touch sensor in the present specification although the infrared sensor may not be regarded as being included in a touch panel.

The touch sensor TS is integral to the display panel DP in the present embodiment. When this is actually the case, the displacing mechanism MM can displace the display panel DP and the touch sensor TS as a single body.

The touch sensor TS may be physically separated from the display panel DP. When this is actually the case, the displacing mechanism MM may displace only the display panel DP separately from the touch sensor TS and may alternatively displace the display panel DP and the touch sensor TS together.

Note that in the present specification, the touch sensor TS does not include, for example, a device used in a menu operation button disposed near the bottom of the PC monitor and is assumed to be capable of directly being involved in an operation on the image on the display panel DP.

The proximity sensor AS detects an instructive operation member (a human finger or a touch pen) approaching a position in a range that is within a prescribed distance from the display panel DP (e.g., in a range at a distance of not more than 10 cm from the display surface of the display panel DP). When this is actually the case, the person in front of the display surface of the display panel DP is likely to be watching the display surface of the display panel DP. The proximity sensor AS may be, for example, a sensor using infrared light or a sensor using ultrasonic waves. The proximity sensor AS may be disposed, for example, on the front face of the frame FR of the display device 100.

The touch sensor TS and the proximity sensor AS may be a single sensor. As an example, some electrostatic capacity touch sensors TS can also detect an approaching instructive operation member (detects “hovering”).

The processing unit PU generates image data for a display on the display panel DP and transmits the generated image data to the displacement control unit MC. The processing unit PU receives an operation signal from the touch sensor TS and performs processes of, for example, altering the image to be displayed on the display panel DP in accordance with the operation signal.

The displacement control unit MC receives the image data outputted from the processing unit PU. The displacement control unit MC displaces the position of the image displayed on the display panel DP in accordance with the passage of time. The image may be displaced in the up/down direction, the left/right direction, or in any direction that is a combination of these, relative to the display surface of the display panel DP. In addition, the displacement control unit MC may rotate (displace) the image displayed on the display panel DP on the display surface of the display panel DP around a rotation axis that is perpendicular to the display surface.

The displacement control unit MC outputs the generated, post-displacement image data to the display panel DP. The displacement control unit MC displaces the display panel DP itself at the same displacement speed as the displacement speed of the position of the displayed image in the display panel DP in a direction opposite the direction of the displacement direction of the position of the displayed image in the display panel DP, by controlling the displacing mechanism MM. This makes the viewer of the image being displayed on the display surface of the display panel DP feel as if the position of the image was spatially stationary.

The displacement control unit MC receives sensing data that enables determining that the instructive operation member (human finger or touch pen) has approached a position that is in the prescribed range of the proximity sensor AS. Hence, the displacement control unit MC detects that the instructive operation member has approached the position within the prescribed distance from the display surface of the display panel DP. As a result, the displacement control unit MC suspends the displacement of the position of the image in the display panel DP. As the displacement of the position of the image in the display panel DP is suspended, the displacement control unit MC also suspends the displacement of the display panel DP itself by controlling the displacing mechanism MM.

Note that the display device 100 may not include the displacing mechanism MM. When this is actually the case, the display panel DP itself is not displaced even if the image displayed on the display panel DP is displaced.

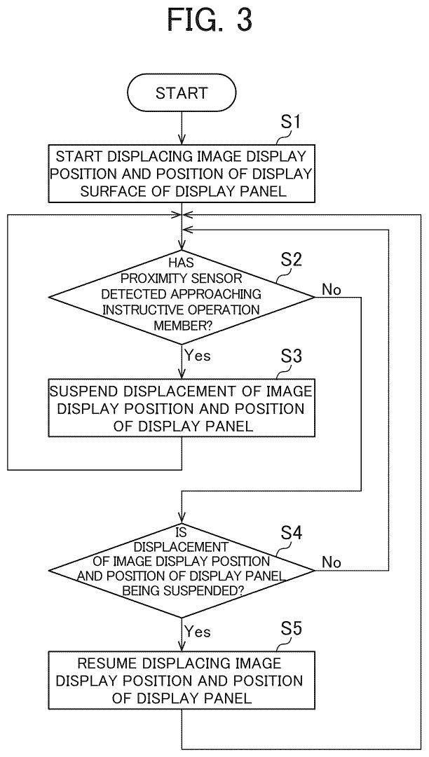

FIG. 3 is a flow chart representing a process performed by the control unit CT for the display device 100 in accordance with Embodiment 1.

In step S1, the displacement control unit MC causes to start displacing the position of the image in the display panel DP and displacing the display panel DP itself. The displacement control unit MC causes to displace the position of the image in the display panel DP and to displace the display panel DP itself at the same speed in mutually opposite directions. At this time, the viewer of the image displayed on the display surface of the display panel DP feels as if the position of the image was spatially stationary. In step S2, the displacement control unit MC determines whether or not the proximity sensor AS has detected an approaching instructive operation member. In other words, it is determined whether or not an instructive operation member has approached a position that is in a prescribed range of the display surface of the display panel DP. Note that if an instructive operation member, for example, a human finger or a touch pen held by the person, has approached, for example, a position in a range that is within 10 cm from the display surface of the display panel DP, the person is likely to be watching the display surface of the display panel DP. In the present embodiment, the displacement control unit MC receives, from the proximity sensor AS, a viewing signal indicating that the viewer is likely to be watching the display surface of the display panel DP. Hence, upon receiving the viewing signal, the displacement correction control unit MC determines that the proximity sensor AS has detected an approaching instructive operation member.

In step S2, as it is determined that the instructive operation member has approached a position that is in a prescribed range of the display surface of the display panel DP, the displacement control unit MC, in step S3, causes to suspend the displacement of the position of the image in the display panel DP and the displacement of the display panel DP itself. Thereafter, the displacement control unit MC repeats the process of step S2. In some cases, the instructive operation member is not determined, in step S2, to have approached a position that is in a prescribed range of the display surface of the display panel DP. In such cases, the displacement control unit MC, in step S4, determines whether or not the displacement of the position of the image in the display panel DP and the displacement of the display panel DP itself are being suspended. If it is determined in step S4 that the displacement of the position of the image in the display panel DP and the displacement of the display panel DP itself are not being suspended, the displacement control unit MC performs the process of step S2. If it is determined in step S4 that the displacement of the position of the image in the display panel DP and the displacement of the display panel DP itself are being suspended, the displacement control unit MC, in step S5, causes to resume the displacement of the position of the image in the display panel DP and the displacement of the display panel DP itself.

As described above, the control unit CT for the display device 100 in accordance with the present embodiment includes the display panel DP including the plurality of self-luminous elements SL. There are cases where the displacement control unit MC receives a viewing signal indicating that the viewer is likely to be watching the display surface of the display panel DP while causing to displace the position, in the display panel DP, of the image ICP displayed on the display panel DP. In such cases, the displacement control unit MC causes to suspend the displacement of the position of the image ICP in the display panel DP. As described earlier, the viewing signal indicates that the viewer's finger or an instructive operation member for manual operation on the display panel DP has approached a position within a prescribed distance from the display surface of the display panel DP.

The display device 100 includes the touch sensor TS on the display surface side of the display panel DP. Additionally, the touch sensor TS is integrated into the display panel DP. Therefore, the displacement control unit MC may receive the viewing signal from the touch sensor TS. The viewing signal in such a case similarly indicates that a person is likely to be watching the display surface of the display panel DP. The display device 100 includes the sensor AS for sending the viewing signal to the displacement control unit MC. The display surface of the display panel DP is planar.

According to the display device 100 in accordance with the present embodiment, the person approaches the display device 100 and watches the displayed image when trying to touch the touch sensor TS. In other words, the person is likely to be watching the image displayed on the display surface of the display panel DP. The aforementioned related art displaces the display panel DP itself while displacing the position of the image in the display panel DP, to restrain image burn-in of the display panel DP, even in such a situation. In such a case, even if the displacement of the image and the displacement of the display panel DP are controlled so that the position of the image displayed on the display panel DP is spatially the same, the viewer still senses the aforementioned displacements and is distracted by the displacements. Furthermore, when the display panel DP and the touch sensor TS are displaced as a single body, the finger can also be displaced, for example, if the touch sensor TS is touched with the finger. Therefore, the viewer of the display panel DP comes to have a sense of strangeness. In addition, the viewer cannot touch a proper position on the touch sensor TS.

In contrast to this, the display device 100 in accordance with the present embodiment suspends the displacement of the image in the display panel DP and the displacement of the display panel DP itself when the display device 100 has detected, through the proximity sensor AS, that an instructive operation member is approaching the display panel DS. Therefore, the image burn-in of the display surface of the display panel DP can be prevented without letting the viewer of the display panel DP feel the displacement of the position of the image in the display panel DP and the displacement of the display panel DP itself.

Therefore, the displacement control unit MC in accordance with the present embodiment may determine that the viewer is watching the display panel DP, by detecting an instructive operation member approaching the touch sensor TS. This enables correctly detecting a person watching the display surface of the display panel DP because the person is extremely likely to be watching the display surface of the display panel DP when touching the touch sensor TS.

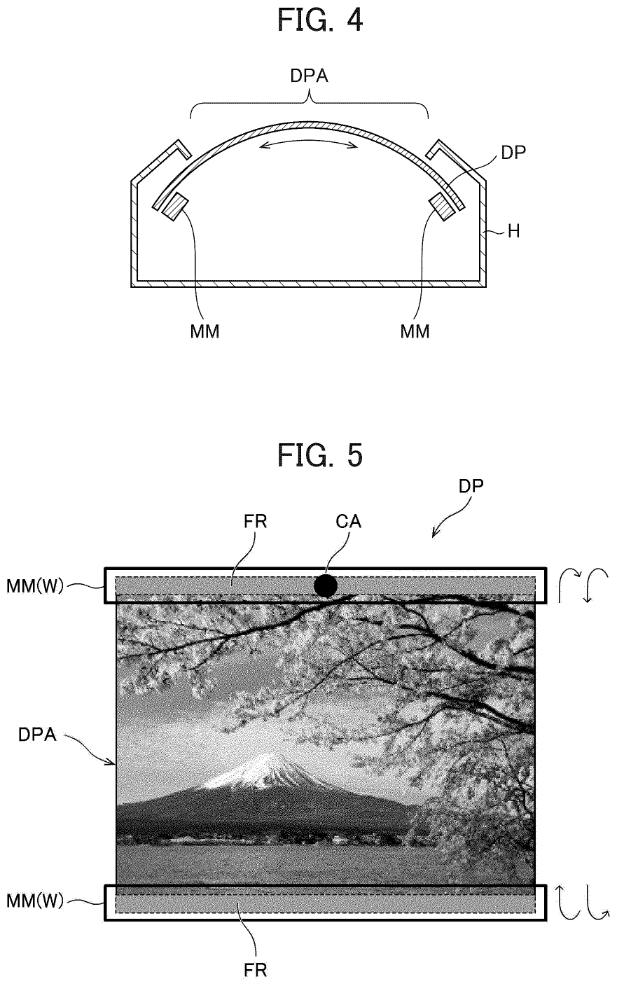

FIG. 4 is a cross-sectional view of a display panel for a variation example of the display device 100 in accordance with Embodiment 1.

Referring to FIG. 4, the display panel DP is not necessarily planar. More specifically, the display surface of the display panel DP may be curved. As an example, the display panel DP may have a cross-section that resembles a part of a cylindrical shape, that is, may have a horizontal cross-section that resembles an arc. Note that the display panel DP may be shaped, for example, like an arc, a part of a spherical surface, or a cylinder. It should be understood however that the cylindrical display panel DP may be described as being shaped like a loop (detailed later).

The display panel DP shown in FIG. 4 has a display surface with an arc-like horizontal cross-section for producing an image display on an external surface thereof. In addition, the display panel DP has a visually recognizable area DPA that is exposed outside a housing H and is shaped like an arc. Here, the displacing mechanism MM displaces the display panel DP along the arc-shaped display surface of the display panel DP. Here, the displacement control unit MC again controls the displacing mechanism MM to displace the display panel DP in a direction opposite the displacement direction of the position of the image in the display panel DP.

Note that unlike the display device 100 shown in FIG. 4, the display surface may be provided for producing an image display on an internal surface of the arc-shaped display panel DP.

### Embodiment 2

Referring to FIGS. 5 to 13, a description is given of a control unit CT for a display device 100 and a method of controlling the display device 100 in accordance with Embodiment 2. Note that the description similar to the control unit CT for the display device 100 and the method of controlling the display device 100 in accordance with Embodiment is not repeated below. The control unit CT for the display device 100 and the method of controlling the display device 100 in accordance with the present embodiment differs from the control unit CT for the display device 100 and the method of controlling the display device 100 in accordance with Embodiment 1 as detailed in the following.

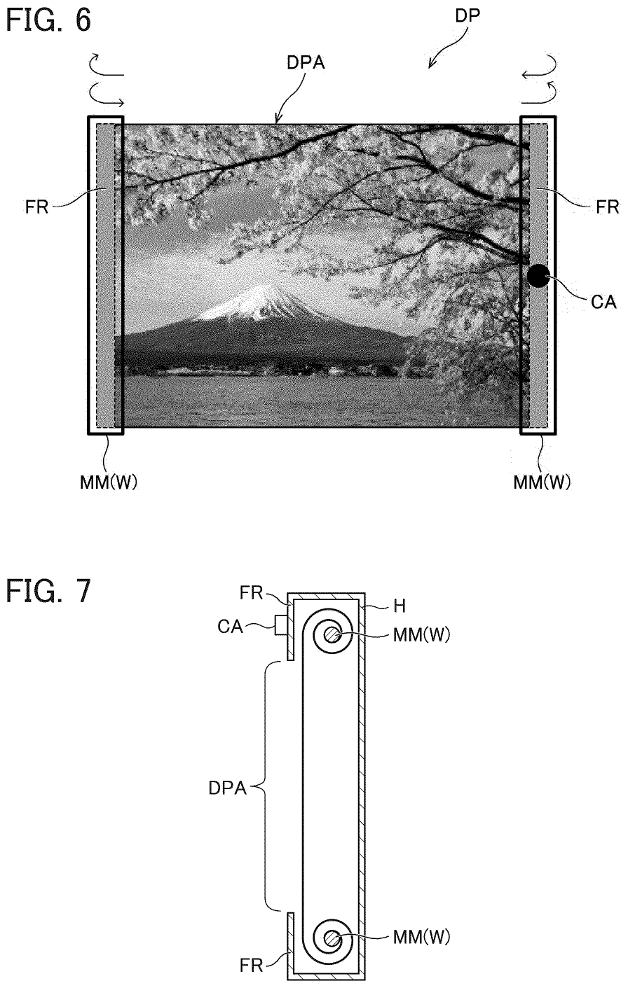

FIG. 5 is a front view of the display device 100 including first roll-up units W as another example of the display device in accordance with Embodiment 2. FIG. 6 is a front view of the display device 100 including second roll-up units W as yet another example of the display device 100 in accordance with Embodiment 2. FIG. 7 is a cross-sectional view of the display device 100 including either the first roll-up units W as another example of the display device 100 in accordance with Embodiment 2 or the second roll-up units W as yet another example of the display device 100 in accordance with Embodiment 2.

As can be seen from FIGS. 5 to 7, the displacing mechanism MM in accordance with the present embodiment includes a roll-up mechanism for the display panel DP (the two first roll-up units W or the two second roll-up units W). Here, the display panel DP is soft so as to be rolled up. The display panel DP has a planar visually recognizable area DPA. The two first roll-up units W are disposed parallel to each other.

Specifically, referring to FIGS. 5 and 7, the roll-up mechanism may be the two first roll-up units W disposed respectively on the upper and lower ends of the display panel DP. Here, the upper one of the first roll-up units W rolls up the upper end of the display panel DP, and the lower one of the first roll-up units W rolls up the lower end of the display panel DP. Therefore, the display panel DP itself can be displaced in the up/down direction, and the position of the image in the display panel DP can be displaced in a direction opposite the displacement direction of the display panel DP itself.

In addition, referring to FIGS. 6 and 7, the roll-up mechanism may be the two second roll-up units W disposed respectively on the far left and far right sides of the display panel DP. Here, the left one of the second roll-up units W rolls up the far left side of the display panel DP, and the right one of the second roll-up units W rolls up the far right side of the display panel DP. Therefore, the display panel DP itself can be displaced in the left/right direction, and the position of the image in the display panel DP can be displaced in a direction opposite the displacement direction of the display panel DP itself.

In the display device in accordance with the present embodiment shown in FIGS. 5 to 7, the displacing mechanism MM displaces the display surface of the display panel DP parallel to the display surface along the display surface.

The display device 100 (rollable display device) in accordance with the present embodiment includes a camera CA used to detect a human face. The camera CA is disposed on the front face of the frame FR of the housing H. It should be understood however that the camera CA may be disposed in a location other than on the housing H.

The display device 100 in accordance with the present embodiment differs from the display device 100 in accordance with the aforementioned embodiment in that the former suspends the displacement of the display panel DP itself and the displacement of the position of the image in the display panel DP upon detecting that the viewer's face is facing the display panel DP.

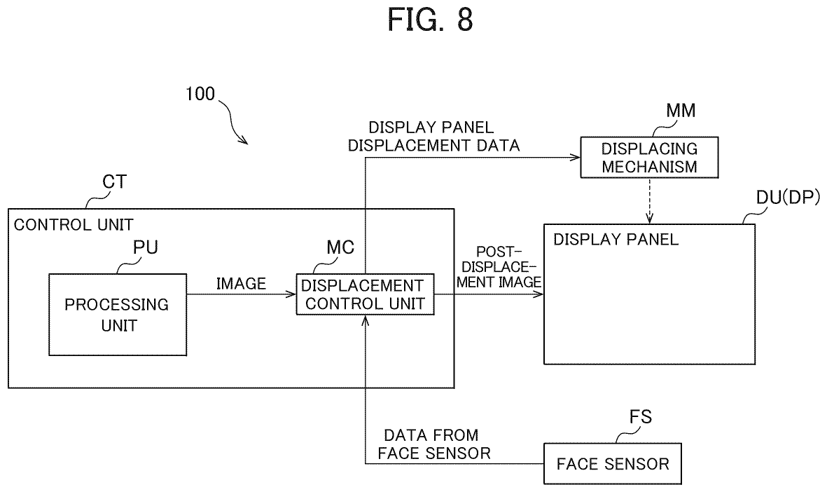

FIG. 8 is a functional block diagram of a configuration of the display device 100 in accordance with the present embodiment. As can be seen from FIG. 8, the display device 100 in accordance with the present embodiment differs from the display device 100 in accordance with Embodiment 1 in that the former includes a face sensor FS in place of the proximity sensor AS.

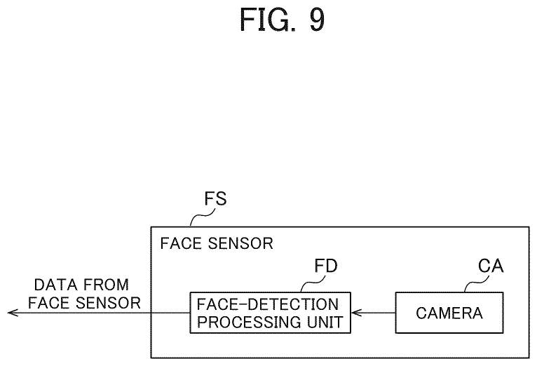

FIG. 9 is a functional block diagram of an internal configuration of the face sensor FS in the display device 100 in accordance with the present embodiment.

The face sensor FS includes the camera CA and a face-detection processing unit FD. The camera CA transmits image data obtained by capturing an image of an approaching object in the vicinity of the display panel DP to the face-detection processing unit FD. A face detection unit FD determines whether or not the human face contained in the image data is likely to be facing the display surface of the display panel DP. Here, the person is regarded as likely to be watching the display surface of the display panel DP if the human face contained in the image data is likely to be facing the display surface of the display panel DP. Hence, the face-detection processing unit FD outputs, to the displacement control unit MC, a face detection signal that enables determining that the person is likely to be watching the display surface of the display panel DP. Whether or not the person is likely to be watching the display surface of the display panel DP may be determined, for example, by extracting a profile image from differences in color or shade in the image data and determining whether or not the profile image resembles the profile image of the front side of a standard human face. In addition, if the image data shows a black circular portion in a white portion, whether or not the human face is facing the display surface of the display panel DP may be determined by determining whether or not the image is close to circular and resembles the pupil of a human eye.

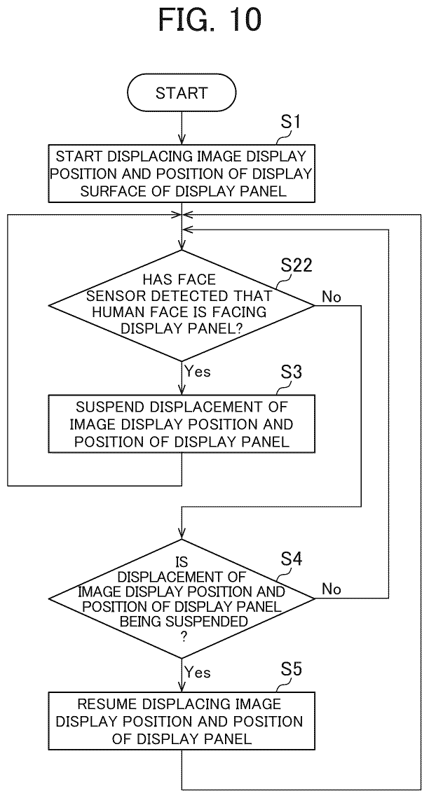

FIG. 10 is a flow chart representing a process performed by the control unit CT for the display device 100 in accordance with Embodiment 2.

The process performed by the control unit CT in accordance with the present embodiment differs only in that the process of step S2 performed by the control unit CT in accordance with Embodiment 1 is replaced by step S22. In step S22, the displacement control unit MC determines whether or not the human face contained in the image data obtained through image capturing by the camera CA is likely to be facing the display panel DR In other words, whether or not the viewer is likely to be watching the display panel DP is determined while the displacement control unit MC is causing to displace the position, in the display panel DP, of the image ICP displayed on the display panel DR If the human face contained in the image data obtained through image capturing by the camera CA is determined to be likely to be facing the display surface of the display panel DP, the control unit CT performs the process of step S3. On the other hand, if the human face contained in the image data obtained through image capturing by the camera CA is not determined to be likely to be facing the display surface of the display panel DP, the control unit CT performs the process of step S4.

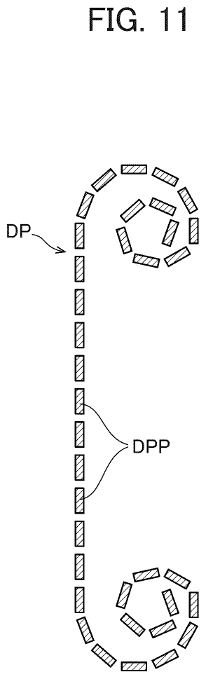

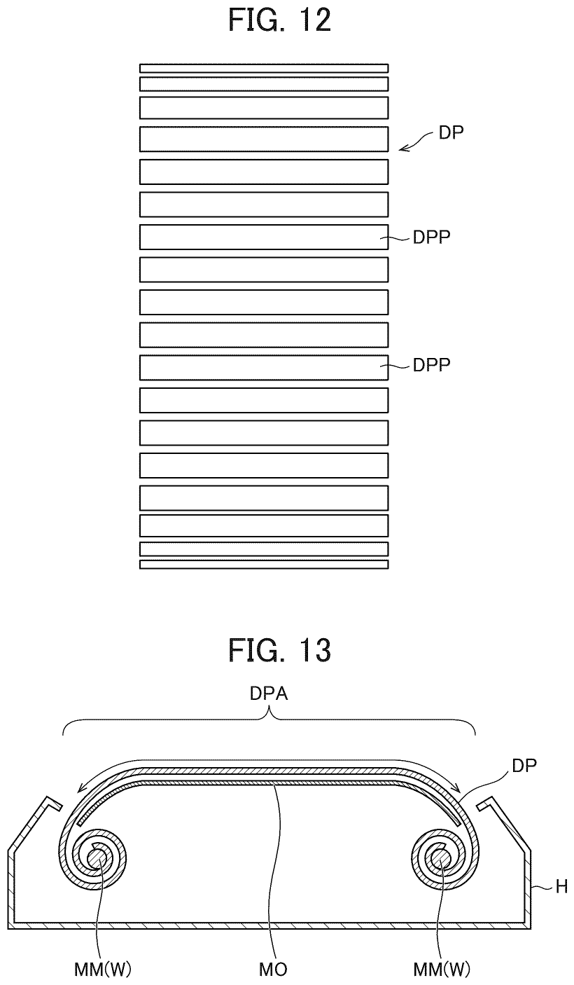

FIGS. 11 and 12 are a cross-sectional view and a front view respectively of the display panel DP for a variation example of the display device 100 in accordance with Embodiment 2.

The display panel DP in accordance with the present embodiment may be flexible as described above, but is not necessarily so. For example, referring to FIGS. 11 and 12, the display panel DP may be a plurality of small-width partial display panels DPP connected like caterpillar treads. In such a case, the entire display panel DP may be structured so as to be rolled up by, for example, rollers. The displacing mechanism MM can displace the display surface of the display panel DP shown in FIGS. 11 and 12 parallel to the display surface along the display surface.

FIG. 13 is a cross-sectional view of a display panel for another variation example of the display device 100 in accordance with Embodiment 2.

The aforementioned visually recognizable area DPA of the display panel DP is planar, but is not limited to this. The visually recognizable area DPA is not necessarily planar. For example, referring to FIG. 13, the visually recognizable area DPA may include a curved surface. Furthermore, referring to FIG. 13, the visually recognizable area DPA may be a curved surface with a non-constant curvature. If the display panel DP is flexible, the display surface of the display panel DP may be displaced along the surface shape of, for example, a formwork MO or a support member. In other words, the displacing mechanism MM may displace the display surface of the display panel DP shown in FIG. 13 parallel to the display surface along the display surface.

Upon detecting, through the face sensor FS, that the human face is likely to be facing the display panel DS, in other words, that the viewer is likely to be watching the display panel DP, the display device 100 suspends the displacement of the image in the display panel DP and the displacement of the display panel DP itself. Therefore, the display device 100 in accordance with the present embodiment can also restrain the image burn-in of the display surface of the display panel DP without letting the viewer of the display panel DP feel the displacement of the position of the image in the display panel DP and the displacement of the display panel DP itself.

When the display device 100 in accordance with the present embodiment is used as a display device in an on-board driver console, the camera CA in the face sensor FS may be disposed, for example, upwards in front of the driver sitting in the driver's seat, not on the frame FR of the display panel DP. The camera CA, disposed in such a location, can capture an image of the driver's face from the front, enabling the face-detection processing unit FD to more readily detect the orientation of the face.

### Embodiment 3

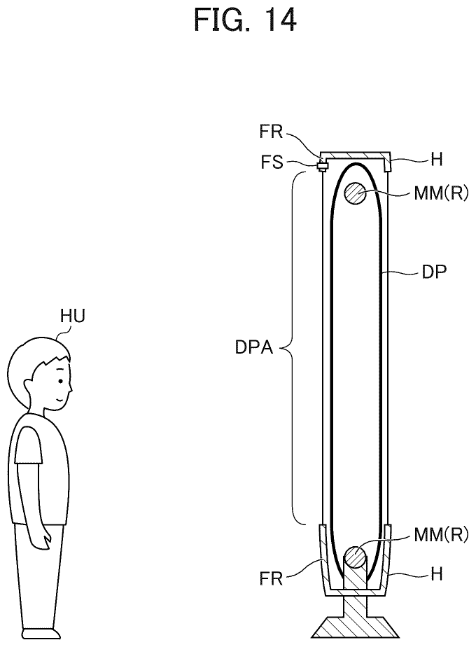

Referring to FIGS. 14 to 18, a description is given of a control unit CT for a display device 100 and a method of controlling the display device 100 in accordance with Embodiment 3. Note that the description similar to the control unit CT for the display device 100 and the method of controlling the display device 100 in accordance with Embodiment is not repeated below. The control unit CT for the display device 100 and the method of controlling the display device 100 in accordance with the present embodiment differs from the control unit CT for the display device 100 and the method of controlling the display device 100 in accordance with Embodiment 1 as detailed in the following.

FIG. 14 is a cross-sectional view of an overall structure of the display device 100 in accordance with the present embodiment.

Referring to FIG. 14, the display panel DP in accordance with the present embodiment is flexible or soft and forms a loop. The displacing mechanism MM includes a rotation mechanism R that rotates the display panel DP along the loop the display panel DP. The rotational displacement of the display panel DP along the loop has some constraints due to, for example, the wiring connecting the display panel DP to the control unit CT, but is given some degree of freedom.

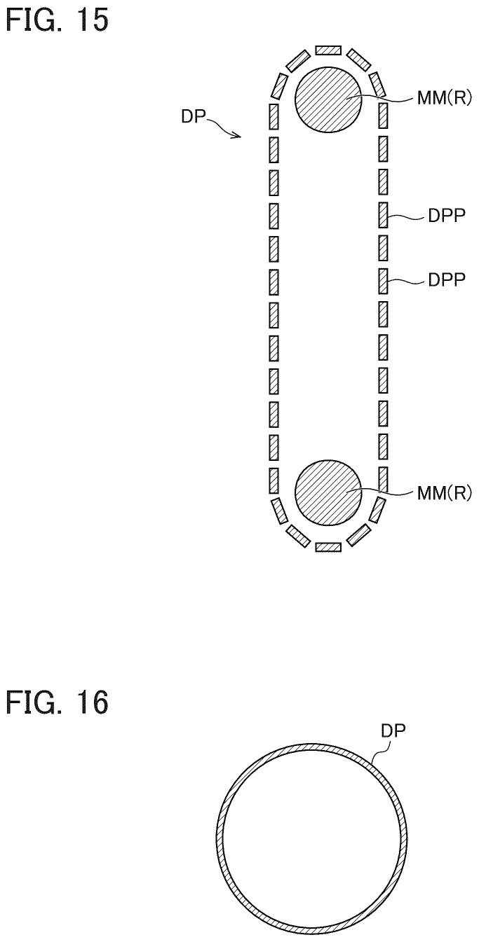

FIG. 15 is a cross-sectional view of the display panel DP and the rotation mechanism R for another example of the display device 100 in accordance with the present embodiment.

The display panel DP in accordance with the present embodiment example may be flexible or soft as described above, but is not necessarily so. For example, referring to FIG. 15, the display panel DP may be a plurality of small-width partial display panels DPP connected like caterpillar treads. In such a case, the entire display panel DP may be structured so as to be rotatable along the loop by, for example, rollers. Note that the plan view of the display panel DP structured like caterpillar treads shown in FIG. 15 may be the same as the one shown in FIG. 12.

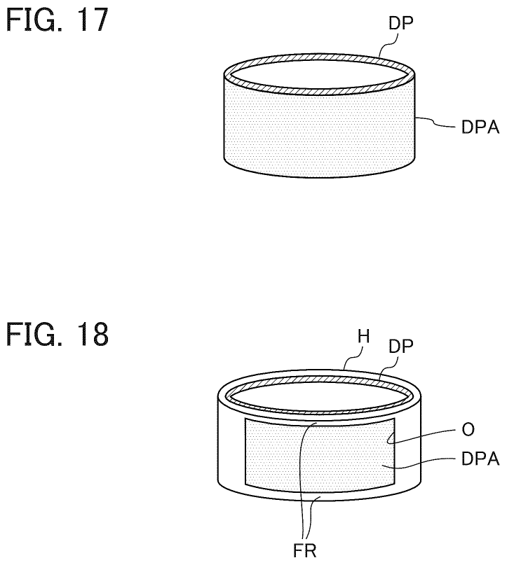

FIG. 16 is a cross-sectional view of the display panel DP for yet another example of the display device 100 in accordance with present Embodiment 3. FIG. 17 is a perspective view of the display panel DP for yet another example of the display device 100 in accordance with the present embodiment. FIG. 18 is a perspective view illustrating a relationship between the display panel DP and a housing H for yet another example of the display device 100 in accordance with the present embodiment.

In addition, referring to FIGS. 16 to 18, the display panel DP in accordance with the present embodiment may be shaped like a cylinder with zero flexibility and softness. If the display panel DP is shaped like a cylinder, the display surface of the display panel DP can be displaced along the display surface by a rotation even when the display panel DP is not flexible or soft. Note that FIGS. 16 to 18 do not show, for example, the wiring connected to the rotation mechanism R and the display panel DP.

The display panel DP in accordance with the present embodiment may be flexible or soft as described earlier and may alternatively be a display panel that resembles caterpillar treads as shown in FIG. 15.

In addition, the display panel DP in accordance with the present embodiment may be a rigid cylindrical display panel as shown in FIGS. 16 and 17. In addition, referring to FIG. 18, the display panel DP may be contained in the housing H, and the housing H may have an opening O so as to expose the visually recognizable area DPA of the display panel DP to the outside. The viewer can see the image displayed in the visually recognizable area DPA of the display panel DP through the opening O.

The displacing mechanism MM in accordance with the present embodiment is a mechanical mechanism for displacing the display surface of the loop-shaped display panel DP along the display surface in response to a control signal received from the displacement control unit MC.

The displacing mechanism MM in accordance with the present embodiment is the rotation mechanisms R disposed respectively on the upper and lower portions of the display panel DP as shown in FIGS. 14 and 15. The displacing mechanism MM displaces the display panel DP itself by rotating (displacing) the loop-shaped display panel DP in response to the control signal received from the displacement control unit MC. In the case of the display panel DP shown in FIGS. 14 and 15, the display panel DP itself can be displaced upwards and downwards. It should be understood however that two rotation mechanisms R may be provided on the far left and far right sides, so as to displace the display panel DP in the left/right direction.

### Embodiment 4

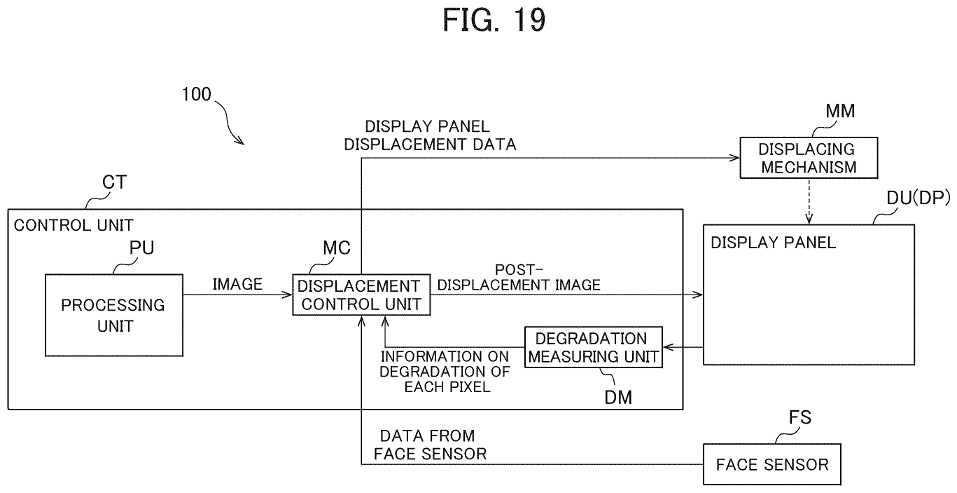

Referring to FIGS. 19 to 23, a description is given of a control unit CT for a display device 100 and a method of controlling the display device 100 in accordance with Embodiment 4. Note that the description similar to the control unit CT for the display device 100 and the method of controlling the display device 100 in accordance with Embodiment is not repeated below. The control unit CT for the display device 100 and the method of controlling the display device 100 in accordance with the present embodiment differs from the control unit CT for the display device 100 and the method of controlling the display device 100 in accordance with Embodiment 1 as detailed in the following.

FIG. 19 is a functional block diagram of a configuration of the display device 100 in accordance with the present embodiment.

Referring to FIG. 19, the display device 100 in accordance with the present embodiment differs from the display device 100 in accordance with the aforementioned embodiment in that the former additionally includes a degradation measuring unit DM for measuring the degradation level of the plurality of self-luminous elements SL. In the present embodiment, the displacement control unit MC controls the displacement of the position in the display panel DP where the image is displayed, in accordance with the degradation level of the plurality of self-luminous elements.

The displacement control unit MM controls the displacement of the position in the display panel DP where the image is displayed to cause the display panel DP to display an image in a region where the degradation level of the plurality of self-luminous elements SL is relatively low.

In addition, the displacement control unit MC may increase the speed of the displacement of the position in the display panel DP where the image is displayed in a case where the display panel DP displays an image in a region where the degradation level of the plurality of self-luminous elements SL is relatively high.

For instance, the degradation measuring unit DM measures the degradation of each self-luminous element SL in the display panel DP immediately after the display device 100 is powered on. Specifically, the degradation measuring unit DM estimates the degradation level of each self-luminous element SL by, measuring, for example, the amount of change of voltage vf applied to that self-luminous element SL or the amount of change of the electron mobility of the TFT (thin film transistor) that drives the self-luminous element SL. These amounts of change can be measured by well-known techniques.

Furthermore, the control unit CT preferentially causes to displace the region where the degradation level of the display panel DP is relatively low to the visually recognizable area DPA, by controlling the displacing mechanism MM on the basis of degradation information transmitted from the degradation measuring unit DM. Hence, the region where the degradation level of the display panel DP is relatively high is prevented from lying in the visually recognizable area DPA as much as possible.

The degradation measuring unit DM in accordance with the present embodiment performs only degradation measurement, but may perform a degradation compensation process as well as degradation measurement. It should be understood however that the degradation compensation process is not an essential element to the display device 100 in accordance with the present disclosure.

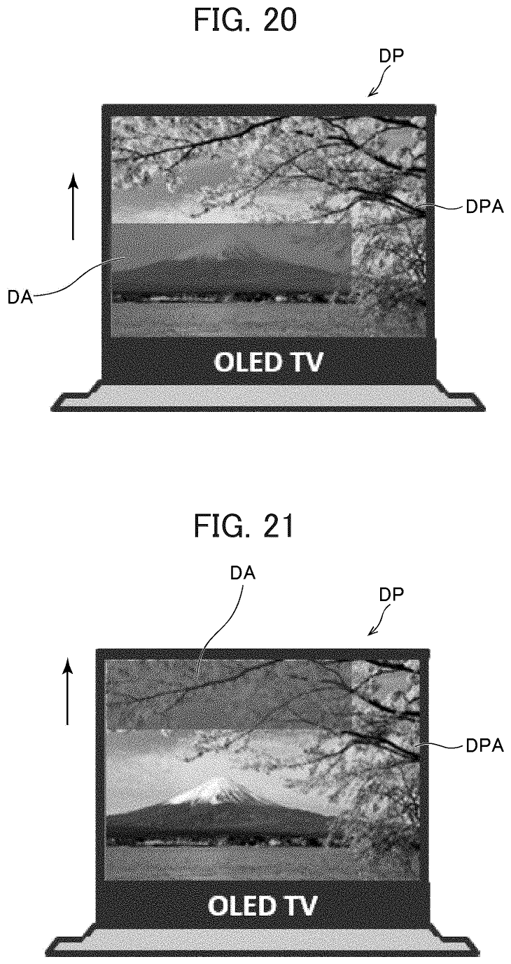

FIG. 20 is a diagram illustrating a degraded area DA before a displayed image is displaced in the display panel DP of the display device 100 in accordance with the present embodiment. The degraded area DAis an area where the degradation level is high when compared with other areas in the display panel DP. FIG. 20 shows the degraded area DA lying in the visually recognizable area DPA of the display panel DP.

FIG. 21 is a diagram illustrating the degraded area DA while a displayed image is being displaced in the display panel DP of the display device 100 in accordance with the present embodiment. FIG. 21 shows the degraded area DA being displaced in the visually recognizable area DPA of the display panel DP.

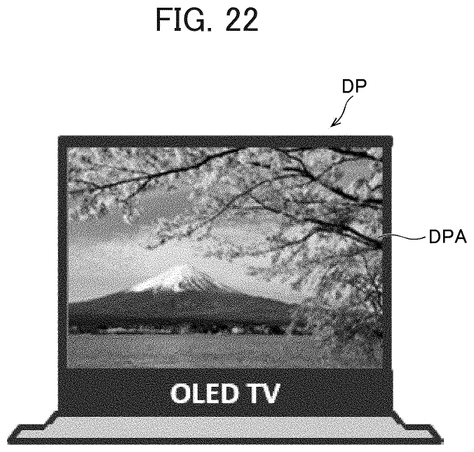

FIG. 22 is a diagram illustrating the degraded area DA being hidden inside the display device 100 after a displayed image is displaced in the display panel DP of the display device 100 in accordance with the present embodiment. FIG. 22 shows a region where the degradation level of the display panel DP is low lying in the visually recognizable area DPA.

The degradation level of the display panel DP including the plurality of self-luminous elements SL can be reduced, for example, through a degradation compensation process such as an external compensation process. However, even the degradation compensation process cannot compensate for the degradation if the degradation level is too high. Therefore, the display panel DP is preferably structured so as not to allow for excessively high local degradation levels.

Therefore, the following processes, as well as the processes in accordance with the aforementioned embodiment, are performed in the present embodiment.

(1) The degradation level of each self-luminous element (pixel) SL in the display panel DP is measured.

(2) The displacing mechanism MM is controlled on the basis of the degradation information representing the measured degradation level of each self-luminous element SL. Hence, the region where the degradation levels of the self-luminous elements SL are low in the display panel DP is preferentially displaced to the visually recognizable area DPA. In other words, the region where the degradation levels of the self-luminous elements SL are high in the display panel DP is prevented from being used as the visually recognizable area DPA as much as possible.

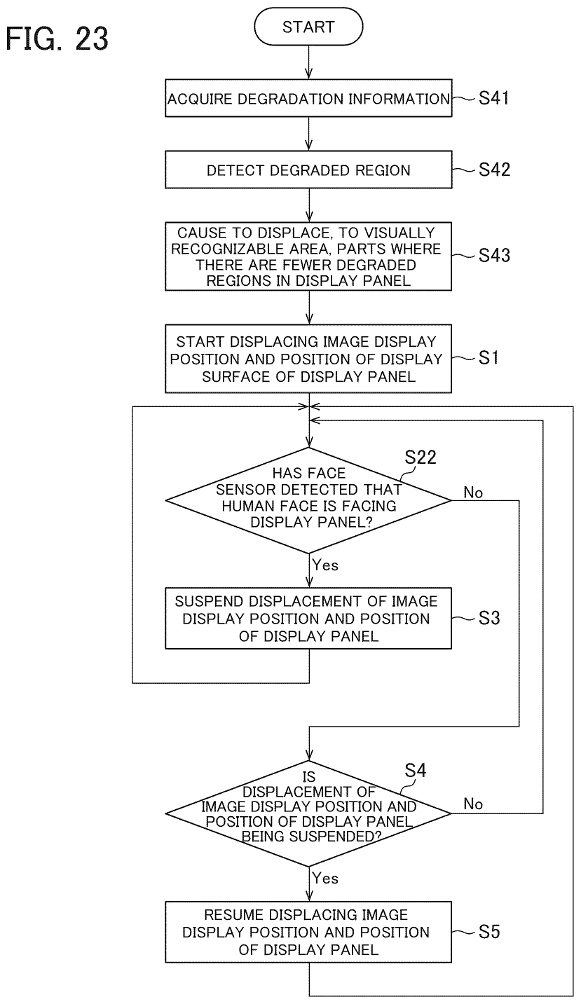

FIG. 23 is a flow chart representing a process performed by the control unit CT for the display device 100 in accordance with the present embodiment.

The process performed by the control unit CT in accordance with the present embodiment differs from the process performed by the control unit CT in accordance with the aforementioned embodiment in that the former includes steps S41 to S43.

In step S41, in the control unit CT, the degradation measuring unit DM acquires degradation information by measuring the degradation level of each self-luminous element SL in the display panel DP after the display device 100 is powered on. In step S42, the displacement control unit MC detects a degraded region where there is a continuous row of at least a prescribed number of pixels that have degraded by at least a prescribed amount, by using the degradation information. This detection can be performed by a well-known technique such as a labeling process. In step S43, the displacement control unit MC in the control unit CT controls the displacing mechanism MM on the basis of the information on the degraded regions detected in step S42 so as to displace those parts where there are fewer degraded regions in the display panel DP to the viewable area DPA. In addition, according to this, the displacement control unit MC in the control unit CT also displaces the position in the display panel DP where the image is displayed.

Note that in the present embodiment, the control unit CT performs the process of steps S41 to S43 once after the display device 100 is powered on, but may perform the process of steps S41 to S43 at regular intervals, for example, once every hour.

The process performed by the control unit CT in accordance with the present embodiment includes the process of additional steps S41 to S43 when compared with the process performed by the control unit CT in accordance with the aforementioned embodiment. In the process of steps S41 to S43, the degradation level of each self-luminous element SL in the display panel D is measured, and those parts where there are fewer degraded regions in the display panel DP are displaced to the viewable area DPAin accordance with the degradation levels. This process allows for average degradation of the entire display panel DP. Hence, the display panel DP is restrained from developing those parts where the degradation level is locally high. As a result, the display device 100 can enjoy an extended lifespan.

### Embodiment 5

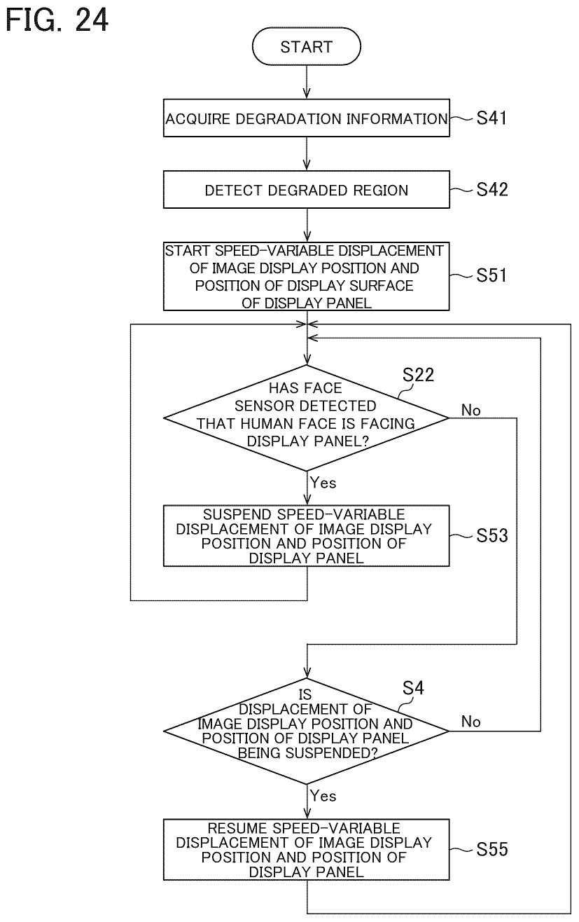

Referring to FIG. 24, a description is given of a control unit CT for a display device 100 and a method of controlling the display device 100 in accordance with Embodiment 5. Note that the description similar to the control unit CT for the display device 100 and the method of controlling the display device 100 in accordance with Embodiment is not repeated below. The control unit CT for the display device 100 and the method of controlling the display device 100 in accordance with the present embodiment differs from the control unit CT for the display device 100 and the method of controlling the display device 100 in accordance with Embodiment 1 as detailed in the following.

The control unit CT in accordance with the present embodiment adjusts the displacement speed of the display panel DP itself by controlling the displacing mechanism MM on the basis of the aforementioned degradation information. Displacing a region where the degradation level is high to the position of the viewable area DPA increases the displacement speed of the display panel DP itself, whereas displacing a region where the degradation level is high to a position that is not the position of the viewable area DPA decreases the displacement speed of the display panel DP itself.

FIG. 24 is a flow chart representing a process performed by the control unit CT for the display device 100 in accordance with the present embodiment.

The process performed by the control unit CT in accordance with the present embodiment differs from the process performed by the control unit CT in accordance with the aforementioned embodiment in that the former includes steps S51, S53, and S55 in place of step S1, S3, and S5.

In step S51, the displacement control unit MC in the control unit CT starts a process of displacing, with passage of time, the position in the display panel DP where the image is displayed and the position of the display panel DP itself. The control unit CT causes to displace the position in the display panel DP where the image is displayed, for example, one pixel every second. Simultaneously with this, the control unit CT causes to rotate (displace) the display panel DP itself by a distance equivalent to one pixel in a direction opposite the displacement direction of the position in the display panel DP where the image is displayed.

In addition, when there is a region where the degradation level is relatively high in the position of the viewable area DPA, the control unit CT relatively increases the displacement of the position in the display panel DP where the image is displayed and the displacement of the display panel DP itself (in other words, increases displacement speed). On the other hand, when there is no region where the degradation level is relatively high in the position of the viewable area DPA, the control unit CT relatively decreases the displacement of the position in the display panel DP where the image is displayed and the displacement of the display panel DP itself (in other words, decreases displacement speed). This process of step S51 will hereinafter be referred to as the “speed-variable displacement.”

If the face sensor FS detects in step S22 that the human face is facing the display surface of the display panel DP, the displacement control unit MC, in step S53, suspends the speed-variable displacement of the position in the display panel DP where the image is displayed and the speed-variable displacement of the position of the display panel DP itself.

In some cases, it is determined in step S4 that the speed-variable displacement of the position in the display panel DP where the image is displayed and the speed-variable displacement of the position of the display panel DP itself are being suspended. In such cases, in step S55, the displacement control unit MC resumes the speed-variable displacement of the position in the display panel DP where the image is displayed and the speed-variable displacement of the position of the display panel DP itself.

As described above, the control unit CT in accordance with the present embodiment performs the following processes. First, the degradation levels of the self-luminous elements SL in the display panel DP are measured. Hence, when there is a region where the degradation levels of the self-luminous elements SL are relatively high in the position of the viewable area DPA, the control unit CT relatively increases the displacement of the position in the display panel DP where the image is displayed and the displacement of the display panel DP itself (in other words, increases displacement speed). On the other hand, when there is no region where the degradation levels of the self-luminous elements SL are relatively high in the position of the viewable area DPA, the control unit CT relatively decreases the displacement of the position in the display panel DP where the image is displayed and the displacement of the display panel DPA itself (in other words, decreases displacement speed). In other words, the control unit CT performs a speed-variable displacement process. This speed-variable displacement process allows for average degradation of the entire display panel DP. Hence, the display panel DP is restrained from local degradation. As a result, the display device 100 can enjoy an extended lifespan.

### Embodiment 6

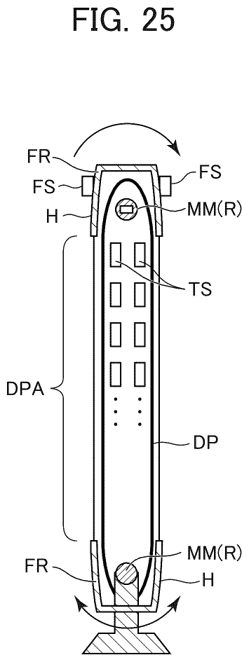

Referring to FIGS. 25 to 29, a description is given of a control unit CT for a display device 100 and a method of controlling the display device 100 in accordance with Embodiment 6. Note that the description similar to the control unit CT for the display device 100 and the method of controlling the display device 100 in accordance with Embodiment is not repeated below. The control unit CT for the display device 100 and the method of controlling the display device 100 in accordance with the present embodiment differs from the control unit CT for the display device 100 and the method of controlling the display device 100 in accordance with Embodiment 1 as detailed in the following.

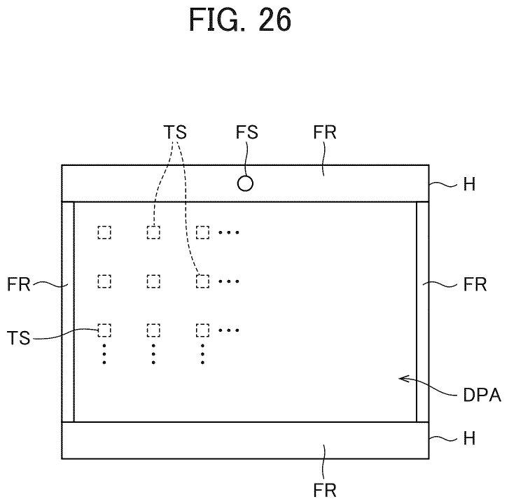

FIGS. 25 and 26 are a cross-sectional view and a front view respectively of an overall structure of the display device 100 in accordance with the present embodiment.

Referring to FIGS. 25 and 26, the display panel DP in accordance with the present embodiment is also shaped like a loop. It should be understood however that the display device 100 in accordance with the present embodiment differs from the display device 100 in accordance with the aforementioned embodiment in that the former has visually recognizable areas DPA, one each on the front side and on the rear side of the loop-shaped display panel DP. In addition, the face sensor FS is used also in the present embodiment, to determine whether or not the person is likely to be watching the display surface of the display panel DP.

The display device 100 in accordance with the present embodiment differs from the display device 100 in accordance with the aforementioned embodiment in that the former includes, on the inside of the loop-shaped display panel DP which is invisible to the viewer, a plurality of temperature sensors TS for measuring the temperature of each location in the display panel DP. In the present embodiment, the plurality of temperature sensors TS are disposed in a matrix on the rear side of the displayable area DPA of the display panel DP.

As the temperature of each part of the display panel DP as detected by the temperature sensors TS becomes high, the degradation of the self-luminous elements SL and the drive TFTs in the display panel DP is accelerated. Therefore, when the surface temperature of the display panel DP as detected by the temperature sensors TS reaches a prescribed high temperature, the control unit CT rotates (displaces) the loop-shaped display panel DP itself along the loop. Note that the temperature of the display panel DP can rise possibly due to factors external to the display device 100, such as sunlight radiation on the display panel DP, other than the current flow in the self-luminous elements SL.

As can be seen from FIGS. 25 and 26, the display device 100 in accordance with the present embodiment is a double-sided display device the displayable area DPA of which is visible from both the front and the back. However, the display device 100 in accordance with the present embodiment is not necessarily a double-sided display device. In addition, the display device 100 in accordance with the aforementioned embodiment may be a double-sided display device.

Note that the two face sensors FS are provided respectively for the two visually recognizable areas DPA of the display panel DP.

Each temperature sensor TS transfers the measured temperature data for the corresponding location in the display panel DP to the displacement control unit MC. As the temperature a location in the display panel DP reaches a particular level, the displacement control unit MC starts causing to rotate the rotation mechanism R as the displacing mechanism MM. In addition, as the rotation starts, the displacement control unit MC can adjust the rotational speed of the display panel DP. The displacement control unit MC gradually increases and decreases the speed of the rotation (displacement) of the display panel DP on the basis of the temperature data acquired through the temperature sensors TS.

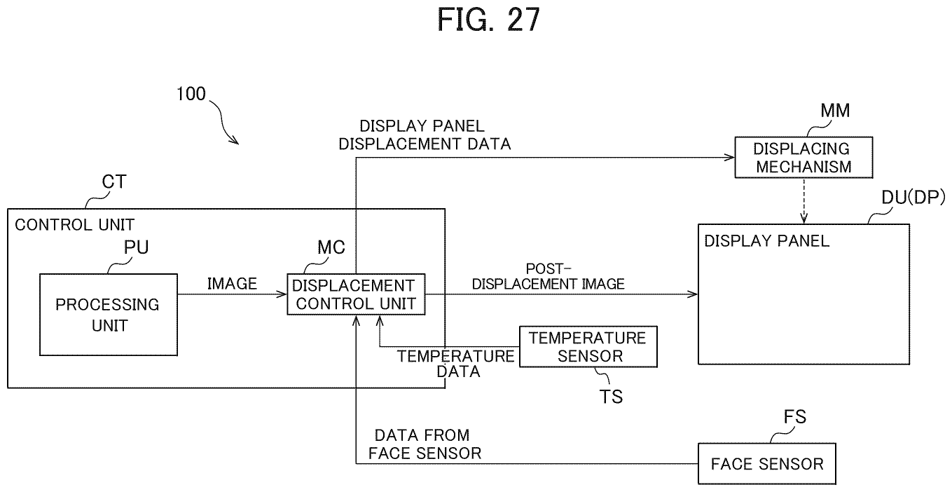

FIG. 27 is a functional block diagram of a configuration of the display device 100 in accordance with the present embodiment.

Referring to FIG. 27, the display device 100 in accordance with the present embodiment differs from the aforementioned embodiment in that the display device 100 includes a plurality of temperature sensors TS for measuring the temperature of the surface of the display panel DP.

For instance, the plurality of temperature sensors TS are attached to an inner circumference side of the loop-shaped display panel DP. Each temperature sensor TS, for example, measures the temperature of the part, of the display panel DP, that is in contact with the temperature sensor TS from the inner circumference side of the display panel DP. Each temperature sensor TS transfers the measured temperature data to the displacement control unit MC.

The displacement control unit MC in accordance with the present embodiment performs control (1) and/or (2) below on the basis of the temperature data received from the temperature sensors TS.

(1) As the temperature of the display panel DP reaches a particular level, the displacement control unit MC starts causing the displacement of the position in the display panel DP where the image is displayed and the rotation (displacement) of the display panel DP itself.

Reaching a particular level may refer to, for example, a maximum value in the temperature data obtained through the plurality of temperature sensors TS increasing to or beyond a prescribed value. For example, the display panel DP can be degraded even when a part of the display panel DP reaches a particular level of high temperature. Therefore, such local degradation of the display panel DP can be restrained through control (1) above.

In the present embodiment, the surface temperature of the display panel DP could rise when the ambient temperature of the display device 100 has risen and when the image data requires high luminance with the display panel DP. When the temperature of the display panel DP has risen due to the content of the image displayed on the display panel DP (high luminance), the pixel at a position heated in the display panel DP is replaced by another pixel in the rotation (displacement) of the display panel DP itself. This rotation (displacement) can restrain the local heat generation of the display panel DP that could raise the temperature of a particular identical pixel to a particular level of temperature.

In addition, when the surrounding environment such as sunlight has raised the temperature of the display panel DP, the rotation (displacement) of the display panel DP itself can also displace the pixel at a position heated in the display panel DP to the opposite side of the display panel DP (the side where the impact of the heat is smaller). Furthermore, the adverse effects of heat on the display panel DP can be reduced by the rotation (displacement) of the display panel DP itself causing circulation of the ambient air of the display panel DP.

(2) The displacement of the position in the display panel DP where the image is displayed and the rotation (displacement) of the display panel DP itself may be, in some cases, ongoing. In such a case, the displacement control unit MC alters the displacement speed of the position in the display panel DP where the image is displayed and the rotation (displacement) speed of the display panel DP itself on the basis of the temperature data acquired through the temperature sensors TS. As an example, the displacement speed of the position in the display panel DP where the image is displayed and the rotation (displacement) speed of the display panel DP itself are increased with an increase in the maximum value in the temperature data acquired through the plurality of temperature sensors TS.

In the present embodiment, the display panel DP itself is rotated (displaced) with the position of the image being watched by viewer being fixed. If the rotational speed is increased when the temperature of the display panel DP is higher, the exchange interval for the pixels in the same position is reduced. Therefore, the adverse effects of heating on particular pixels can last for a shorter period of time. As a result, the display device 100 can enjoy an extended lifespan.

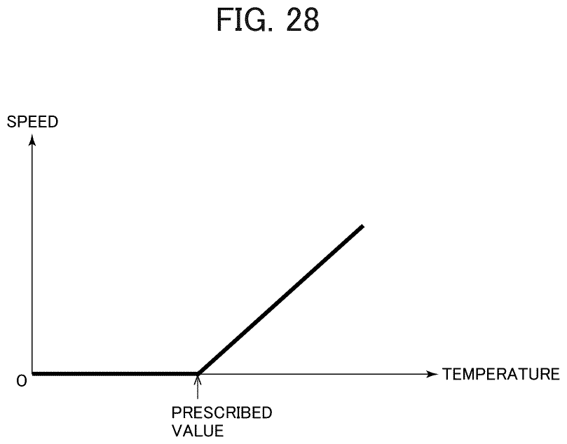

FIG. 28 is a graph representing a relationship between the temperature of the display panel DP of the display device 100 in accordance with the present embodiment, the displacement speed of the position in the display panel DP where the image is displayed, and the rotation (displacement) speed of the display panel DP itself. Values on the horizontal axis indicate a maximum value in the temperature data acquired through the plurality of temperature sensors TS. Values on the vertical axis indicate the displacement speed of the position in the display panel DP where the image is displayed and the rotation (displacement) speed of the display panel DP itself. Note that the graph in FIG. 28 shows a case where both control (1) and control (2) described above are implemented.

As can be seen from FIG. 28, if the maximum value in the temperature data acquired through the plurality of temperature sensors TS in process (1) described above is less than or equal to a prescribed value, the displacement speed of the position in the display panel DP where the image is displayed and the rotation (displacement) speed of the display panel DP itself are equal to 0. On the other hand, if the maximum value in the temperature data acquired through the plurality of temperature sensors TS exceeds the prescribed value, the displacement of the position in the display panel DP where the image is displayed and the rotation (displacement) of the display panel DP itself are started.

As can be seen from FIG. 28, the displacement speed of the position in the display panel DP where the image is displayed and the rotation (displacement) speed of the display panel DP itself increase with an increase in the maximum value in the temperature data acquired through the plurality of temperature sensors TS, as a result of process (2) described above.

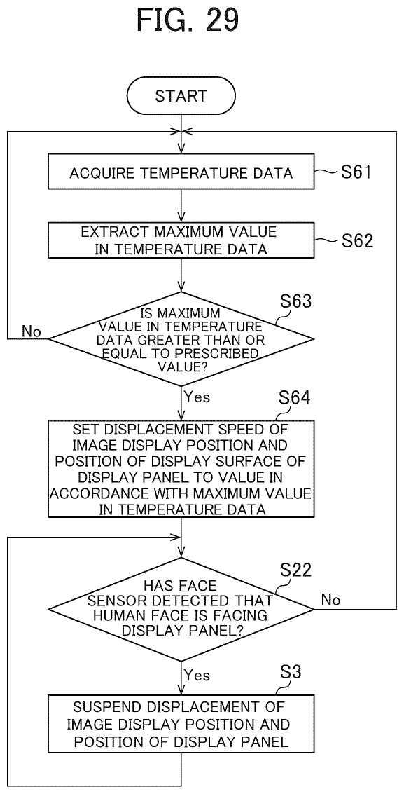

FIG. 29 is a flow chart representing a process performed by the control unit CT for the display device 100 in accordance with the present embodiment.

The process performed by the control unit CT in accordance with the present embodiment differs from the process performed by the control unit CT in accordance with the aforementioned embodiment in that the former includes steps S61 to S64, but does not include step S1, S4, or S5 and also in the process performed if the result of step S22 is “No.” More specific description follows.

In step S61, the displacement control unit MC acquires a plurality of pieces of temperature data from the plurality of temperature sensors TS. In step S62, the displacement control unit MC determines a maximum value in the plurality of pieces of temperature data acquired from the plurality of temperature sensors TS. In step S63, the displacement control unit MC determines whether or not the maximum value in the temperature data is greater than or equal to a prescribed value.

In step S63, the control unit CT performs the process of step 64 if the maximum value in the temperature data is greater than or equal to the prescribed value and on the other hand performs the process of step S61 again if the maximum value in the temperature data is not greater than or equal to the prescribed value.

In step S64, the displacement control unit MC sets the rotation (displacement) speed of the position in the display panel DP where the image is displayed and the displacement speed of the position of the display surface of the display panel DP itself to a value that is in accordance with the maximum value in the temperature data. In so doing, the displacement control unit MC alters the rotational speed or the displacement speed if the rotation (displacement) of the position in the display panel DP where the image is displayed and the displacement of the position of the display surface of the display panel DP itself have already been performed. If the displacement of the image display position and the displacement of the position of the display surface of the display panel have not been performed yet, the displacement is started at the speeds specified above.

In other words, the displacement control unit MC in accordance with the present embodiment receives a signal representing the temperature of the display panel DP and controls the displacement of the position of the image in the display panel DP on the basis of the signal representing the temperature.

### Embodiment 7

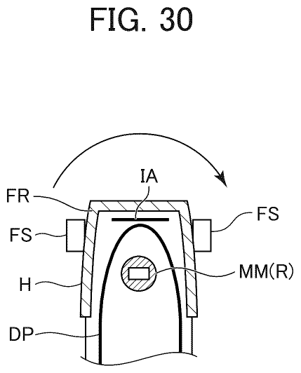

Referring to FIGS. 30 to 34, a description is given of a control unit CT for a display device 100 and a method of controlling the display device 100 in accordance with Embodiment 7. Note that the description similar to the control unit CT for the display device 100 and the method of controlling the display device 100 in accordance with Embodiment is not repeated below. The control unit CT for the display device 100 and the method of controlling the display device 100 in accordance with the present embodiment differs from the control unit CT for the display device 100 and the method of controlling the display device 100 in accordance with Embodiment 1 as detailed in the following.

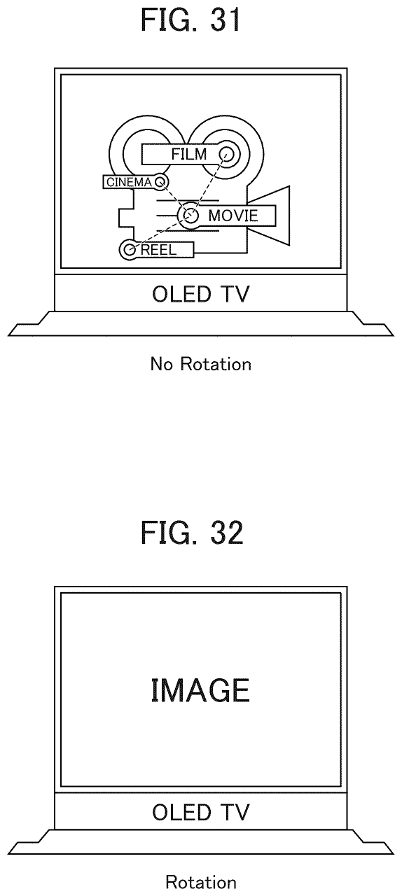

FIG. 30 is a cross-sectional view of a structure of a part of the display device 100 in accordance with the present embodiment. FIG. 31 is a diagram illustrating an exemplary display state when the display panel DP of the display device 100 in accordance with the present embodiment is not rotated. FIG. 32 is a diagram illustrating an exemplary display state when the display panel DP of the display device 100 in accordance with the present embodiment is rotated.

The display panel DP in accordance with the present embodiment is shaped like a loop. The display panel DP includes a face sensor FS for detecting that the human face is likely to be facing the display surface of the display panel DP. It should be understood however that the display device 100 in accordance with the present embodiment differs from the display device 100 in accordance with the aforementioned embodiment in that the control unit CT includes an image analysis unit IA.

In the present embodiment, the image analysis unit IA and the displacement control unit MC control the speed of the displacement of the position in the display panel DP where the image is displayed and the rotation (displacement) speed of the display panel DP itself in accordance with the type of the image. The image analysis unit IA and the displacement control unit MC control the speed of the displacement of the position in the display panel DP where the image is displayed and the rotation (displacement) speed of the display panel DP itself, for example, in accordance with whether the image is a still image or a moving image.

For instance, if the image displayed on the display panel DP is a still image, the control unit CT causes the displacing mechanism MM to displace (rotate) the display panel DP along the loop. On the other hand, if the image displayed on the display panel DP is a moving image, the control unit CT either does not cause to displace (rotate) the display panel DP or reduces the rotation (displacement) speed of the display panel DP in comparison with when the image displayed on the display panel DP is a still image.

Whether or not the rotation (displacement) of the display panel DP is rotated is determined depending on the type of the input image data received by the image analysis unit IA from the processing unit PU. If the input image data is, for example, a movie as shown in FIG. 31, the image burn-in of the display panel DP is unlikely because information differs from one frame to the other. In such a case, there is no need for the displacement of the position in the display panel DP where the image is displayed and for the rotation (displacement) of the display panel DP itself. Therefore, the displacement control unit MC does not cause the displacing mechanism MM to perform the displacement of the position in the display panel DP where the image is displayed and the rotation (displacement) of the display panel DP itself. On the other hand, if the input image data is, for example, signage as shown in FIG. 32, the image burn-in of the display panel DP is likely because information for each frame does not change. In such a case, the displacement control unit MC causes the displacing mechanism MM to perform the displacement of the position in the display panel DP where the image is displayed and the rotation (displacement) of the display panel DP itself.

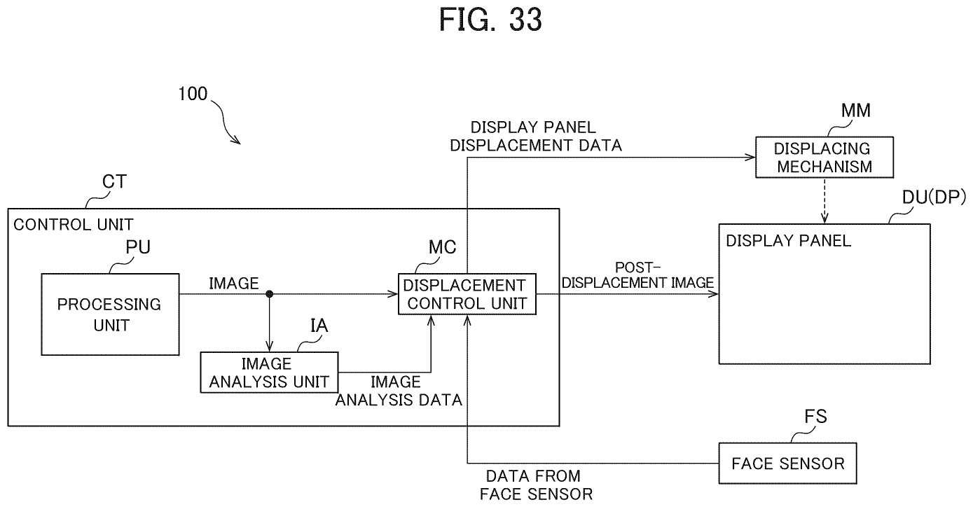

FIG. 33 is a functional block diagram of a configuration of the display device 100 in accordance with the present embodiment.

Referring to FIG. 33, the display device 100 in accordance with the present embodiment differs from the display device 100 in accordance with the aforementioned embodiment in that the control unit CT includes the image analysis unit IA.

The image analysis unit IA receives, from the processing unit PU, the same image data as the image data transmitted from the processing unit PU to the displacement control unit MC. The image analysis unit IA determines whether the image data received from the processing unit PU is a moving image or a still image. For example, the image analysis unit IA counts the number of pixels each of which has a luminance difference that is greater than or equal to a prescribed value between a frame of the image and a next frame of this frame. The image analysis unit IA determines that the received image data is image data for a moving image if the count value is greater than or equal to the prescribed value, in other words, if the number of pixels that have a luminance difference that is greater than or equal to the prescribed value between successive frames exceeds a specific value. On the other hand, the image analysis unit IA determines that the received image data is image data for a still image if the count value is smaller than the prescribed value, in other words, if the number of pixels that have a luminance difference that is greater than or equal to the prescribed value between successive frames is smaller than a specific value. The image analysis unit IA transmits a result of the determination (image analysis data) to the displacement control unit MC.

The displacement control unit MC increases at least either one of the speed and frequency of the displacement of the position of the image in the display panel DP when the image is a still image over when the image is a moving image.

Specifically, if the image data received by the processing unit PU is determined by the image analysis unit IA to be image data for a still image, the displacement control unit MC causes to displace the position in the display panel DP where the image is displayed and the display panel DP itself at a prescribed speed. On the other hand, there are cases where the image data received by the processing unit PU is determined by the image analysis unit IA to be image data for a moving image. When this is actually the case, the displacement control unit MC causes to displace the position in the display panel DP where the image is displayed and the display panel DP itself at a particular speed that is lower than the speed for a case where it is determined that image data for a still image has been received. In this case, the particular speed may be equal to zero, in other words, the displacement of the position of the image in the display panel DP and the displacement of the display panel DP itself may be suspended.

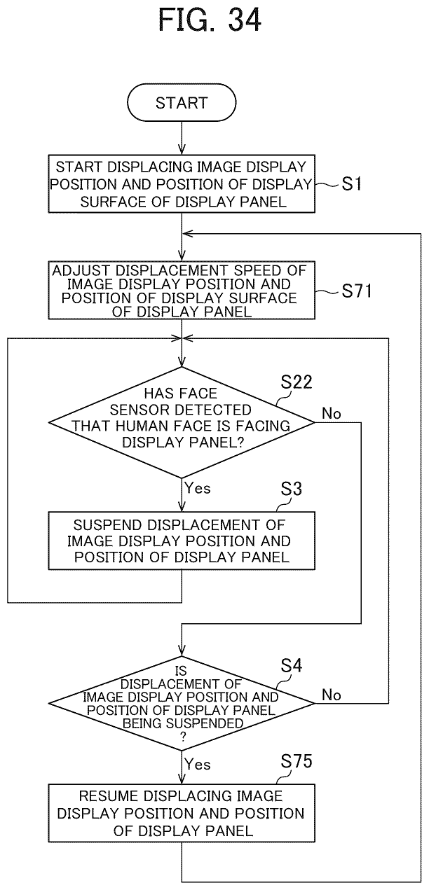

FIG. 34 is a flow chart representing a process performed by the control unit CT for the display device 100 in accordance with the present embodiment.

The process performed by the control unit CT in accordance with the present embodiment differs from the process performed by the control unit CT in accordance with the aforementioned embodiment in that the former includes step S71 and includes step S75 in place of step S5. More specific description follows.

In step S71, the displacement control unit MC adjusts the speed of the displacement of the position in the display panel DP where the image is displayed and the speed of the rotation (displacement) of the position of the display panel DP itself on the basis of a result of the determination received from the image analysis unit IA in the image analysis.

Specifically, if the image analysis unit IA determines that the image received by the processing unit PU is a still image, the displacement control unit MC sets the speed of the displacement of the position in the display panel DP where the image is displayed and the rotation (displacement) speed of the display panel DP itself to a first prescribed value. On the other hand, if the image analysis unit IA determines that the image is a moving image, the displacement control unit MC sets the displacement of the position in the display panel DP where the image is displayed and the speed of the position of the display panel DP itself to a second prescribed value that is smaller than the first prescribed value. Note that the second prescribed value may be equal to zero.

In step S75, the displacement control unit MC resumes the rotation (displacement) of the position in the display panel DP where the image is displayed and the rotation (displacement) of the display panel DP itself if the result of the determination in step S4 is YES. Thereafter, the control unit CT performs the process of step S71. On the other hand, if the image that the processing unit PU has received by the image analysis unit IA is a moving image, the image burn-in is unlikely. Accordingly, if the image is determined to be a moving image, the displacement control unit MC causes to perform the displacement of the position in the display panel DP where the image is displayed and the rotation (displacement) of the display panel DP itself at a speed slower than the speed for a case where the image is determined to be a still image. Hence, the displacement of the position in the display panel DP where the image is displayed and the rotation (displacement) of the display panel DP itself can be rendered less obtrusive.

### Other Embodiments

The structure/configuration of the display unit DU in accordance with any one of the above-described embodiments and the structure/configuration of the control unit CT in accordance with any one of the above-described embodiments may be combined unless such a combination leads to a contradiction. For example, the structure/configuration of the display unit DU in accordance with Embodiment 1 and the structure/configuration of the control unit CT in accordance with Embodiment 2 may be combined. In other words, the planar or curved display panel DP and the face sensor FS may be combined.

In addition, for example, the structure/configuration of the display unit DU in accordance with Embodiment 1 and the structure/configuration of the control unit CT in accordance with Embodiment 4 may be combined. In other words, the planar or curved display panel DP, the face sensor FS, and the degradation measuring unit DM may be combined.

1. A control unit for a display device including a display panel including a plurality of self-luminous elements, the control unit comprising a displacement control unit configured to, while causing to displace a position in the display panel where an image is displayed on the display panel, stop the displacement of the position of the image in the display panel when a viewing signal is received that indicates that a viewer is likely to be watching a display surface of the display panel.

2. The control unit for the display device according to claim 1, wherein the viewing signal indicates that either a finger of the viewer or an instructive operation member by means of which an operation is performed on the display panel has approached a position within a prescribed distance from the display surface of the display panel.

3. The control unit for the display device according to claim 2, wherein the display device includes a touch sensor on a display surface side of the display panel.

4. The control unit for the display device according to claim 3, wherein the touch sensor is integrated into the display panel.

5. The control unit for the display device according to claim 3, wherein the control unit receives the viewing signal from the touch sensor.

6. The control unit for the display device according to claim 2, wherein the viewing signal indicates that a face of the viewer is facing the display panel.

7. The control unit for the display device according to claim 2, wherein the display device includes a sensor that transmits the viewing signal to the displacement control unit.

8. The control unit for the display device according to claim 2, wherein the display surface of the display panel is planar.

9. The control unit for the display device according to claim 2, wherein the display surface of the display panel is curved.

10. The control unit for the display device according to claim 1, wherein
the display device includes a displacing mechanism that displaces the display panel in a direction along the display surface, and
the displacement control unit controls the displacing mechanism to displace the display panel in a direction opposite a displacement direction of the position of the image in the display panel.

11. The control unit for the display device according to claim 10, wherein
the display panel is so soft as to be rolled up, and
the displacing mechanism includes a mechanism that rolls up the display panel.

12. The control unit for the display device according to claim 10, wherein
the display panel forms a loop, and
the displacing mechanism includes a rotation mechanism that rotates the display panel along the loop of the display panel.

13. The control unit for the display device according to claim 1, wherein
a degradation measuring unit is included that measures a degradation level of the plurality of self-luminous elements, and
the displacement control unit controls the displacement of the position of the image in the display panel in accordance with the degradation level of the plurality of self-luminous elements.

14. The control unit for the display device according to claim 13, wherein the displacement control unit controls the displacement of the position of the image in the display panel to cause the display panel to display the image in a region where the degradation level of the plurality of self-luminous elements is lower than in another region.

15. The control unit for the display device according to claim 13, wherein the displacement control unit increases a speed of the displacement of the position of the image in the display panel when the display panel displays the image in a region where the degradation level of the plurality of self-luminous elements is higher than in another region.

16. The control unit for the display device according to claim 1, wherein the displacement control unit receives a signal indicating a temperature of the display panel and controls the displacement of the position of the image in the display panel based on the signal indicating the temperature.

17. The control unit for the display device according to claim 1, wherein the displacement control unit renders at least either one of a speed and a frequency of the displacement of the position of the image in the display panel higher when the image is a still image than when the image is a moving image.

18. A display device comprising:
the display panel; and
the control unit for the display device according to claim 13.

19. A method of controlling a display device including a display panel including a plurality of self-luminous elements; the method comprising:
a step of displacing a position in a display panel where an image is displayed on the display panel; and
a step of, while displacing the position, stopping the displacement of the position of the image in the display panel when a viewing signal is received that indicates that a viewer is likely to be watching a display surface of the display panel.
